(19) United States
(12) Patent Application Publication
(10) Pub. No.: US 2018/0314767 A1
(43) Pub. Date: Nov. 1, 2018

(54) SYSTEMS AND METHODS FOR IMPROVED CHARACTERISTIC ACCOUNTABILITY & VERIFICATION (ECAV) SYSTEM

(71) Applicant: General Electric Company, Schenectady, NY (US)

(72) Inventor: Alexandria Stoker Cochrane, Greenville, SC (US)

(21) Appl. No.: 15/582,499

(22) Filed: Apr. 28, 2017

(51) Int. Cl. G06F 17/50; G06F 3/0481

(52) U.S. Cl. CPC G06F 17/50; G06F 2217/12; G06F 3/04815

(57) ABSTRACT

In one embodiment, a computer-aided technology (CAx) system includes a memory storing a characteristic accountability and verification (eCAV) system. The CAx system further includes a processor communicatively coupled to the memory and configured to execute the eCAV system to receive a computer aided design (CAD) model of a part design as input. The processor is additionally configured to execute the eCAV system to add a callout data to the CAD model based on a product and manufacturing information (PMI) data related to the part design. The processor is also configured to execute the eCAV system to link the callout data to the PMI data.

### BACKGROUND OF THE INVENTION

The subject matter disclosed herein relates to systems and methods for design and inspection of parts, such as a characteristic accountability and verification (eCAV) system.

Certain design and inspection techniques may be used to create a variety of machinery, including industrial machines. Industrial machines, such as gas turbine systems, may provide for the generation of power. For example, the gas turbine systems typically include a compressor for compressing a working fluid, such as air, a combustor for combusting the compressed working fluid with fuel, and a turbine for turning the combusted fluid into a rotative power. For example, the compressed air is injected into a combustor, which heats the fluid causing it to expand, and the expanded fluid is forced through the gas turbine. The gas turbine may then convert the expanded fluid into rotative power, for example, by a series of blade stages. The rotative power may then be used to drive a load, which may include an electrical generator producing electrical power and electrically coupled to a power distribution grid. Industrial machines and machine parts may be designed for a particular purpose, such as a compressor blade designed to compress air. The machine or part may then be inspected for its ability to fulfill its design purpose. It may be beneficial to improve the design and inspection of machine and machine parts, for example, with an improved characteristic accountability and verification (eCAV) system.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a computer-aided technology (CAx) system includes a memory storing a characteristic accountability and verification (eCAV) system. The CAx system further includes a processor communicatively coupled to the memory and configured to execute the eCAV system to receive a computer aided design (CAD) model of a part design as input. The processor is additionally configured to execute the eCAV system to add a callout data to the CAD model based on a product and manufacturing information (PMI) data related to the part design. The processor is also configured to execute the eCAV system to link the callout data to the PMI data.

In a second embodiment, a method for applying a computer-aided technologies (CAx) system includes executing, via a processor, a characteristic accountability and verification (eCAV) system to receive, via the processor, a computer aided design (CAD) model of a part design as input. The method further includes executing, via the processor, the eCAV system to add, via the processor, a callout data to the CAD model based on a product and manufacturing information (PMI) data related to the part design. The method also includes executing, via the processor, a the eCAV system to link, via the processor, the callout data to the PMI data.

In a third embodiment, one or more tangible, non-transitory, machine-readable media including instructions that cause a processor to execute, via the processor, a characteristic accountability and verification (eCAV) system to receive, via the processor, a computer aided design (CAD) model of a part design as input. The instructions are further configured to cause the processor to execute the eCAV system to add, via the processor, a callout data to the CAD model based on a product and manufacturing information (PMI) data related to the part design. The instructions are also configured to cause the processor to execute the eCAV system to link, via the processor, the callout data to the PMI data.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a computer-aided technology (CAx) system;

FIG. 2 is a block diagram of embodiments of certain components of the CAx system of FIG. 1;

FIG. 3 is block diagram of an embodiment, of an industrial system that may be conceived, designed, engineered, manufactured, and/or service and tracked by the CAx system of FIG. 1;

FIG. 4 is a flowchart of an embodiment of a process suitable for incorporating one or more callouts (e.g., CAV data) into a CAD model; and

FIG. 5 is a screenshot of an embodiment of a graphical user interface suitable for creating and adding one or more callouts (e.g., CAV data) into a CAD model.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Designing a machine or part may include certain systems and methods described in more detail below that produce a design for a part or product. For example, the design may be created as a model-based definition included in a 3-dimensional (3D) computer aided design (CAD) model and associated product and manufacturing information (PMI). The techniques described herein may not create typical engineering part drawing or drawings, as the CAD model and PMI may contain all part dimensional and tolerance information, as further described below.

During design, a characteristic accountability and verification (eCAV) system may create a number of callouts (also called balloons or bubbles) associated with specific PMI annotation objects to identify the objects as inspection items. The eCAV system may then generate a characteristic accountability and verification document that lists each of these inspection items with their nominal values, plus/minus tolerances, units, critical-to-quality (CTQ) types, and other details suitable for use by an inspection operator and/or inspection system. The eCAV system may save time by automatically identifying inspection items, and save time by automatically creating the characteristic accountability and verification document. The eCAV system may also prevent re-work of callout definitions and CAV documents in manufacturing, decrease quality issues due to mistyping, and keep data relative to its original definition model.

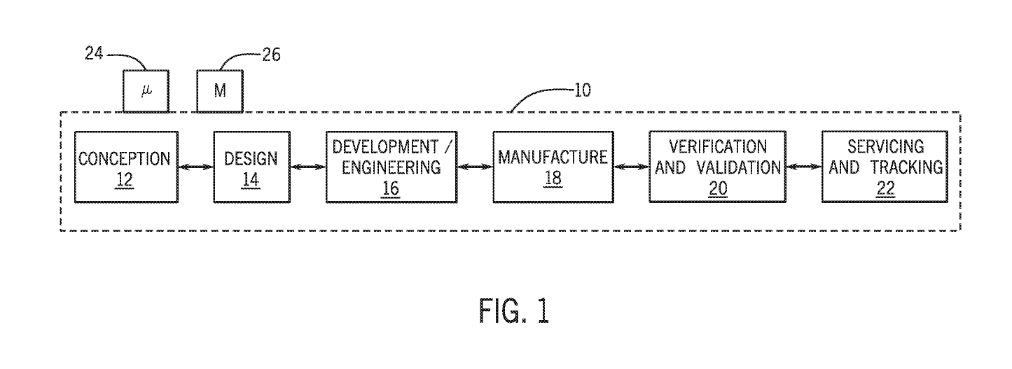

With the foregoing in mind, it may be useful to describe a computer-aided technologies (CAx) system that may incorporate the techniques described herein, for example suitable for executing one or more product lifecycle management (PLM) processes. Accordingly, FIG. 1 illustrates an embodiment of a CAx system 10 suitable for providing for a variety of processes, including PLM processes 12, 14, 16, 18, 20, 22. In the depicted embodiment, the CAx system 10 may include support for execution of conception processes 12. For example, the conception processes 12 may produce a set of specifications such as requirements specifications documenting a set of requirements to be satisfied by a design, a part, a product, or a combination thereof. The conception processes 12 may also produce a concept or prototype for the part or product (e.g., machinery, electronics, structures, or a combination thereof). A series of design processes 14 may then use the specifications and/or prototype to produce, for example, one or more 3D design models of the part or product. The 3D design models may include solid/surface modeling, parametric models, wireframe models, vector models, non-uniform rational basis spline (NURBS) models, geometric models, and the like, describing part geometries and structures. The PMI may include geometric dimensions, tolerances, text (e.g., annotations, notes), other dimensions, material type, material specifications, finishes (e.g., surface finishes), clearances, and so on, associated with the 3D models.

A characteristic accountability and verification (eCAV) system may be used to may create a number of callouts (also called balloons or bubbles) associated with specific PMI annotation objects to identify the objects as inspection items. The eCAV system may then generate a characteristic accountability and verification document that lists each of these inspection items with their nominal values, plus/minus tolerances, units, critical-to-quality (CTQ) types, and other details suitable for use by an inspection operator and/or inspection system. The callouts may be stored alongside the model and may refer to certain modeled parts, thus keeping data relative to its original definition model.

Design models may then be further refined and added to via the execution of development/engineering processes 16. The development/engineering processes may, for example, create and apply models such as thermodynamic models, low cycle fatigue (LCF) life prediction models, multibody dynamics (MBD) and kinematics models, computational fluid dynamics (CFD) models, finite element analysis (FEA) models, and/or 3-dimension to 2-dimension FEA mapping models that may be used to predict the behavior of the part or product during its operation. For example, turbine blades may be modeled to predict fluid flows, pressures, clearances, and the like, during operations of a gas turbine engine. The development/engineering processes 16 may additionally result in the tolerances, materials specifications (e.g., material type, material hardness), clearance specifications, and the like, useful in manufacturing the part or product and stored in the PMI.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, and the like, to create the part or product. Other manufacturing models may be derived, such as computer numeric control (CNC) models with G-code to machine or otherwise remove material to produce the part or product (e.g., via milling, lathing, plasma cutting, wire cutting, and so on). Bill of materials (BOM) creation, requisition orders, purchasing orders, and the like, may also be provided as part of the manufacture processes 18 (or other PLM processes).

The CAx system 10 may additionally provide for verification and/or validation processes 20 that may include automated inspection of the part or product as well as automated comparison of specifications, requirements, and the like. In one example, a coordinate-measuring machine (CMM) process may be used to automate inspection of the part or product. The CMM process may be aided by the use of the eCAV system. For example, the eCAV system may automatically generate a CAV document that may then be used during inspection.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to redesign the part or product via the design processes 14. Indeed, data from any one of the processes 12, 14, 16, 18, 20, 22 may be automatically provided and used by any other of the processes 12, 14, 16, 18, 20, 22 to improve the part or product or to create a new part or a new product. In this manner, the CAx system 10 may incorporate data from downstream (or upstream) processes and use the data to improve the part or to create a new part.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The processors may additionally be included in a cloud-based system that provides for the processes 12, 14, 16, 18, 20, 22 as cloud-based services. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

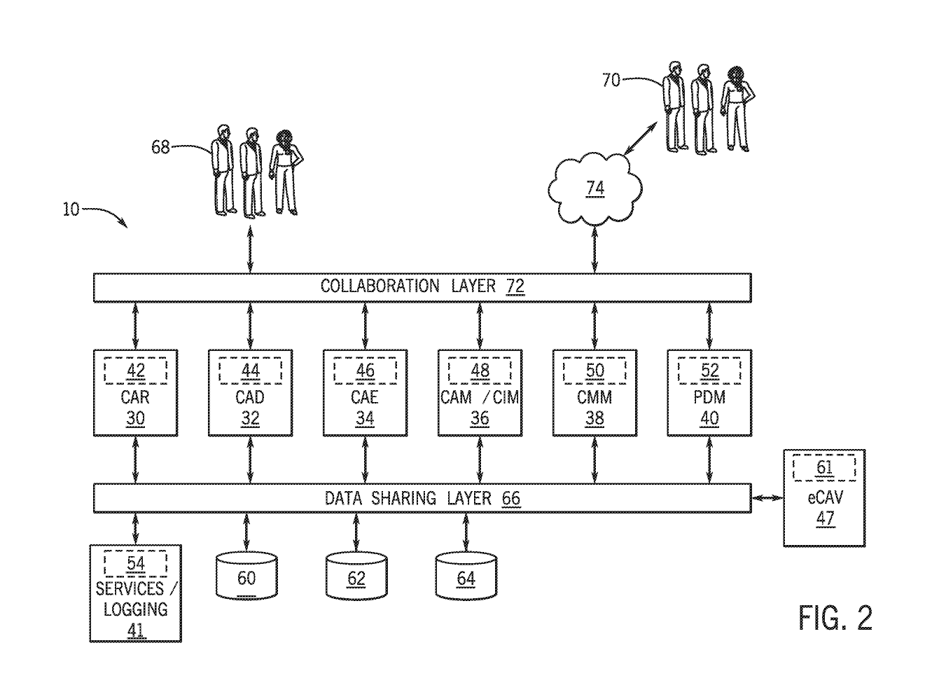

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40, a services/logging system 41, and an electronic characteristic accountability & verification (eCAV) system 47. Each of the systems 30, 32, 34, 36, 38, 40, 41, and 47 may be extensible and/or customizable; accordingly, each system 30 may include an extensibility and customization system 42, 44, 46, 48, 50, 52, 54, and 61, respectively. Additionally, each of the systems 30, 32, 34, 36, 38, 40, 41, and 47 may be stored in a memory system, such as memory system 26, and may be executable via a processor, such as via processors 24.

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models as described above with respect to the design processes 14. For example, the 3D design models may include solid/surface modeling, parametric models, wireframe models, vector models, non-uniform rational basis spline (NURBS) models, geometric models, and the like. The CAD system 32 may provide for the creation and update of the 2D and/or 3D models and related information (e.g., views, drawings, annotations, notes, and so on). Indeed, the CAD system 32 may combine a graphical representation of the part or product with other, related information.

The CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics (MBD) and kinematics models, computational fluid dynamics (CFD) models, finite element analysis (FEA) models, and/or 3-dimension to 2-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof. The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, 38, 40, 41, and/or 47. For example, the systems 30, 32, 34, 36, 38, 40, 41, and 47 may communicate with data repositories 60, 62, 64 via a data sharing layer 66. The PDM system 40 may then manage collaboration between the systems 30, 32, 34, 36, 38, 40, 41, and 47 by providing for data translation services, versioning support, data archive management, notices of updates, and so on. The PDM system 40 may additionally provide for business support such as interfacing with supplier/vendor systems and/or logistics systems for purchasing, invoicing, order tracking, and so on. The PDM system 40 may also interface with the service/logging system 41 (e.g., service center data management systems) to aid in tracking the maintenance and life cycle of the part or product as it undergoes operations. Teams 68, 70 may collaborate with team members via a collaboration layer 72. The collaboration layer 72 may include web interfaces, messaging systems, file drop/pickup systems, and the like, suitable for sharing information and a variety of data. The collaboration layer 72 may also include cloud-based systems 74 or communicate with the cloud-based systems 74 that may provide for decentralized computing services and file storage. For example, portions (or all) of the systems 30, 32, 34, 36, 38, 40, 41, and 47 may be stored in the cloud 74, be executable in the cloud 74, and/or accessible via the cloud 74.

The eCAV 47 system may be used to create and/or update callouts (also known as balloons or bubbles) that get associated with specific PMI annotation objects. The callouts may include, for example, information useful for first article inspection (FAI). The information may thus include distances between edges, positions of holes, diameters and shapes of holes, weight, density, stiffness, color and/or surface finish information. The callout information may also include nominal values, plus/minus tolerances, units, critical-to-quality (CTQ) types, statistical process control (SPC) data, verification (VER) data, dimension type information (e.g., basic, circular, chamfer, degree, diameter, surface finish, radius, reference, surface of revolution, thread, and so on), tolerance type information (e.g., angularity, concentricity, flatness, non-SPC dimension, perpendicularity, parallelism, runout, surface or line profile, true position, and so on).

The callout information may be “linked” to the PMI objects and/or stored as an extension of the PMI objects. Accordingly, the CAV information may be stored and/or associated with the model (e.g., CAD model), thus keeping the CAV data relative to its definition model. In this manner, parts in the model may be redesigned or updated, and the CAV data associated with the parts may be similarly updated as needed. In some embodiments, the eCAV system 47 may be part of or subsystem of the CAD system 32.

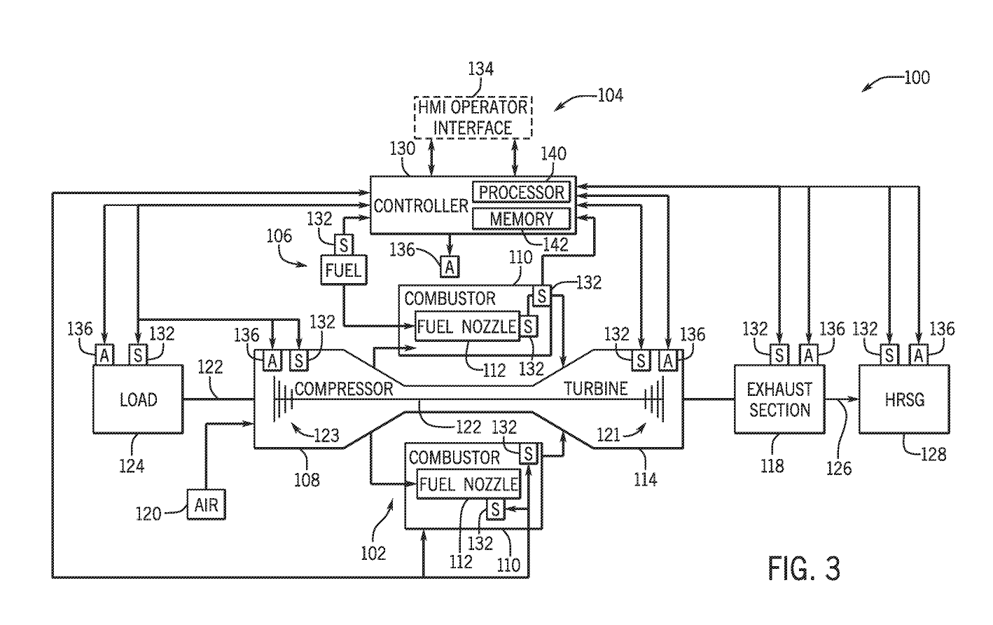

The services/logging system 41 may include shop systems that are used to service a variety of machinery, and that may thus log replacement of parts, track a specific part use in a specific device, track number of hours of use, track maintenance performed, and so on. In one embodiment, the services/logging system 41 may be fleet-based. That is, the services/logging system 41 may store and analyze data for a fleet of machinery, such as a fleet of power-production machinery described in more detail with respect to FIG. 3.

Once the design is updated, the part may then be manufactured and then inspected, for example via the CMM system 38. In one embodiment, the CMM system 38 may execute certain CMM inspection code For example, the code (e.g., dimensional measuring interface standard [DMIS] code, CALYPSO code) may include a set of locations on the part or product that the CMM system may inspect via a probe, a laser, a camera, and so on. The code may additionally include travel paths, a complete measurement plan, allowable variations, for example, in geometry, and so on. Results from the inspection may be used as input to the eCAV system 47. The eCAV system 47 may then automatically generate a first article inspection report and/or metrics detailing the measured geometries, position of holes, type of holes (e.g., through-holes, partial holes), hole depth, hole diameter, hole shape, distance between edges, surface finish, color, and so on.

The extensibility and customization systems 42, 44, 46, 48, 50, 52, 58 and 61 may provide for functionality not found natively in the CAR system 30, the CAD system 32, the CAM/CIM system 36, the CMM system 38, the PDM system 40, the services/logging system 41, and/or the eCAV system 47. For example, computer code or instructions may be added to the systems 30, 32, 34, 36, 38, 40, 41, and 47 via shared libraries, modules, software subsystems and the like, included in the extensibility and customization systems 42, 44, 46, 48, 50, 52, 54, and/or 61. The extensibility and customization systems 42, 44, 46, 48, 50, 52, 54, and 61 may also use application programming interfaces (APIs) included in their respective systems 30, 32, 34, 36, 38, 40, 41, and 47 to execute certain functions, objects, shared data, software systems, and so on, useful in extending the capabilities of the CAR system 30, the CAD system 32, the CAM/CIM system 36, the CMM system 38, the PDM system 40, the services/logging system 41, and/or the eCAV system 47. By enabling the processes 12, 14, 16, 18, 20, and 22, for example, via the systems 30, 32, 34, 36, 38, 40, 41, and 47 and their respective extensibility and customization systems 42, 44, 46, 48, 50, 52, 54, and 61, the techniques described herein may provide for a more efficient “cradle-to-grave” product lifecycle management.

It may be beneficial to describe a machine that would incorporate one or more parts manufactured and tracked by the processes 12, 14, 16, 18, 20, and 22, for example, via the CAx system 10. Accordingly, FIG. 3 illustrates an example of a power production system 100 that may be entirely (or partially) conceived, designed, engineered, manufactured, serviced, and tracked by the CAx system 10. As illustrated in FIG. 3, the power production system 100 includes a gas turbine system 102, a monitoring and control system 104, and a fuel supply system 106. The gas turbine system 102 may include a compressor 108, combustion systems 110, fuel nozzles 112, a gas turbine 114, and an exhaust section 118. During operation, the gas turbine system 102 may pull air 120 into the compressor 108, which may then compress the air 120 and move the air 120 to the combustion system 110 (e.g., which may include a number of combustors). In the combustion system 110, the fuel nozzle 112 (or a number of fuel nozzles 112) may inject fuel that mixes with the compressed air 120 to create, for example, an air-fuel mixture.

The air-fuel mixture may combust in the combustion system 110 to generate hot combustion gases, which flow downstream into the turbine 114 to drive one or more turbine stages. For example, the combustion gases may move through the turbine 114 to drive one or more stages of turbine blades 121, which may in turn drive rotation of a shaft system 122. The shaft system 122 may additionally be coupled to one or more compressor stages having compressor blades 123. The shaft 122 may additionally connect to a load 124, such as a generator that uses the torque of the shaft 122 to produce electricity. After passing through the turbine 114, the hot combustion gases may vent as exhaust gases 126 into the environment by way of the exhaust section 118. The exhaust gas 126 may include gases such as carbon dioxide (CO₂), carbon monoxide (CO), nitrogen oxides (NOₓ), and so forth.

The exhaust gas 126 may include thermal energy, and the thermal energy may be recovered by a heat recovery steam generation (HRSG) system 128. In combined cycle systems, such as the power plant 100, hot exhaust 126 may flow from the gas turbine 114 and pass to the HRSG 128, where it may be used to generate high-pressure, high-temperature steam. The steam produced by the HRSG 128 may then be passed through a steam turbine engine for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the system 100 may also include a controller 130. The controller 130 may be communicatively coupled to a number of sensors 132, a human machine interface (HMI) operator interface 134, and one or more actuators 136 suitable for controlling components of the system 100. The actuators 136 may include valves, switches, positioners, pumps, and the like, suitable for controlling the various components of the system 100. The controller 130 may receive data from the sensors 132, and may be used to control the compressor 108, the combustors 110, the turbine 114, the exhaust section 118, the load 124, the HRSG 128, and so forth.

In certain embodiments, the HMI operator interface 134 may be executable by one or more computer systems of the system 100. A plant operator may interface with the industrial system 100 via the HMI operator interface 134. Accordingly, the HMI operator interface 134 may include various input and output devices (e.g., mouse, keyboard, monitor, touch screen, or other suitable input and/or output device) such that the plant operator may provide commands (e.g., control and/or operational commands) to the controller 130.

The controller 130 may include a processor(s) 140 (e.g., a microprocessor(s)) that may execute software programs to perform the disclosed techniques. Moreover, the processor 140 may include multiple microprocessors, one or more “general-purpose” microprocessors, one or more special-purpose microprocessors, and/or one or more application specific integrated circuits (ASICS), or some combination thereof. For example, the processor 140 may include one or more reduced instruction set (RISC) processors. The controller 130 may include a memory device 142 that may store information such as control software, look up tables, configuration data, etc. The memory device 142 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). As mentioned earlier, all systems, parts, components and so on, of

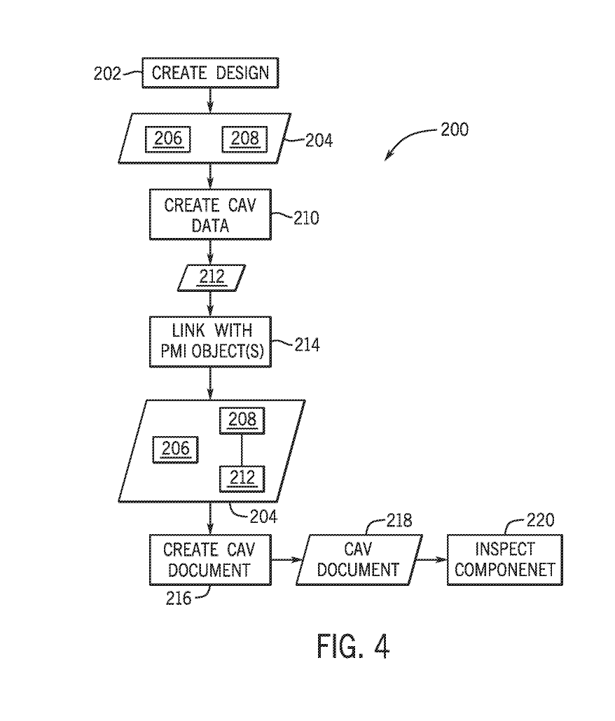

Turning now to FIG. 4, the figure is a flowchart illustrating a process 200 suitable for implementing the techniques described herein, including incorporating one or more callouts (e.g., CAV data) into the a CAD model. The process 200 may be implemented as computer code or instructions stored in the memory 26 and executable via the processor 24. Additionally or alternatively, the process 200 may be implemented in hardware, such as in a custom chip, FPGA chip, and so on. Further, the process 200 may be executable via the cloud 74.

In the depicted embodiment, the process 200 may create (block 202) a part or product design 204. The part or product design may include a 3D CAD model 206 and associated PMI information or objects 208. The model 206 may be created or designed (block 202) for example, by the design processes 14 (e.g., via the CAD system 32). Likewise, the PMI information 208 may be added during the creation of the model 206 by the CAD processes 14 (e.g., via the CAD system 32). As mentioned earlier, the model 206 may include information such as 3D part information, solid/surface modeling, parametric models, wireframe models, vector models, non-uniform rational basis spline (NURBS) models, geometric models, and the like, describing part geometries and structures. Likewise, the PMI information 208 may include geometric dimensions, tolerances, text (e.g., annotations, notes), other dimensions, material type, material specifications, finishes (e.g., surface finishes), clearances, and so on, associated with the 3D model 206.

The process 200 may then create (block 210) CAV data 212, for example, by creating callouts in the CAD model 206. As mentioned earlier, the CAV data 212 may include nominal values, plus/minus tolerances, units of measure, critical-to-quality (CTQ) types, statistical process control (SPC) data, verification (VER) data, dimension type information (e.g., basic, circular, chamfer, degree, diameter, surface finish, radius, reference, surface of revolution, thread, and so on), tolerance type information (e.g., angularity, concentricity, flatness, non-SPC dimension, perpendicularity, parallelism, runout, surface or line profile, true position, and so on). The process 200 may then link (block 214) the CAV or callout data 212 with one or more PMI objects 208. For example, an identifier that uniquely identifies a PMI object 208 (e.g., unique name, unique unlimber, and so on) may be stored in the respective CAV data 212 so that a specific CAV data 212 may refer to one or more specific PMI objects 208. By linking (block 214) the CAV data 212 with corresponding PMI data 208, CAV data 212 may be stored in the design 204 and/or CAD model 206, changes to the design 204 and/or CAD model 206 may be implemented and any resultant CAV data 212 (or PMI 208) changes may be more easily derived and the data 212 (or 208) updated.

For example, changes to the model 206 may be easily performed via the CAD system 32, and CAV data 212 and/or PMI objects 208 may still be associated with certain CAD objects, including CAD objects that may have been updated. The process 200 may then automatically create (block 216) a CAV document 218. For example, the process 200 may query data tables, inspection callouts, and other CAV data 212 while ignoring unrelated text or other unrelated data. Results of the selection may be presented to a user so that the user may edit the selection if desired, before the CAV document 218 is finalized. The process may also identify necessary duplications, such as multiple line items for a chamfer or profile tolerance, and automatically include those duplications in the CAV document 218 generated.

The CAV document 218 may then be used for inspection (block 228) of a product manufactured based on the design 204. More specifically, the CAV document 218 may provide for a “first article inspection” template that then may be filled via inspection systems such as the CMM system 38 and/or via manual inspection of the product that was manufactured. The CAV document 218 may then provide a record that all design and specification requirements were properly understood, accounted for, and documented.

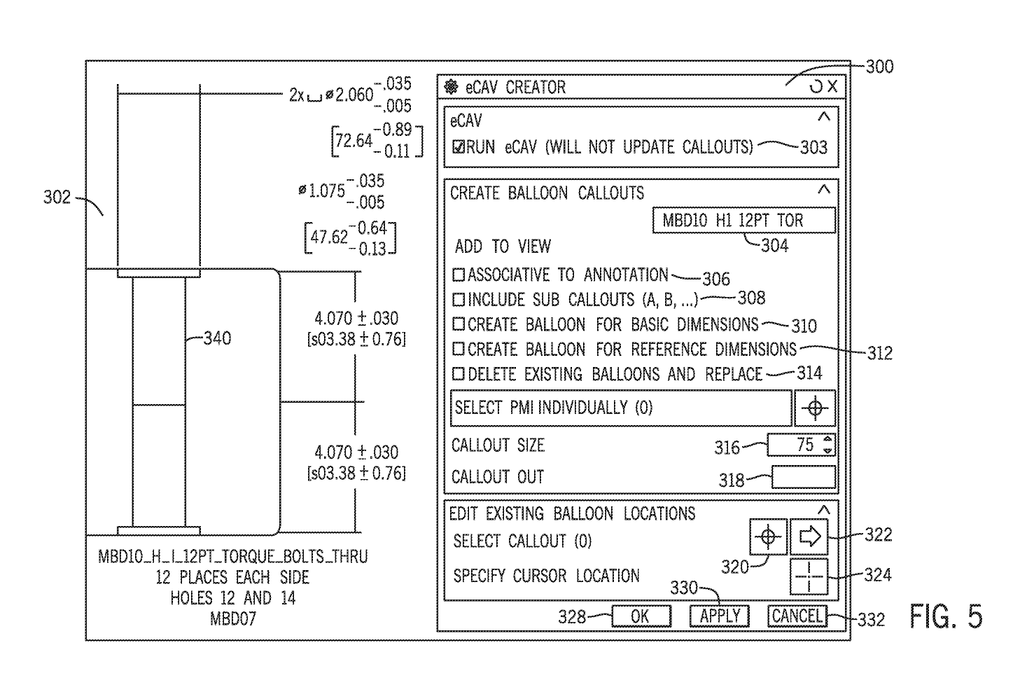

Turning now to FIG. 5, the figure illustrates an embodiment of a graphical user interface 300 suitable for entering and/or visualizing certain CAV data 212. The GUI 300 may be executable, for example, via the processor(s) 24 and stored in the memory 26. In the depicted embodiment, the GUI 300 is shown as a dialog box “floating” over a CAD system 32 display. More specifically, the GUI 300 is shown over a displayed portion 302 of, for example, a part design the CAD model 206.

The GUI 300 includes various controls suitable for entering certain information. For example, radio button 303 may be used to the eCAV system 47, for example, to create the eCAV document 216. A drop-down control 304 may be used to create a callout in a specific view of the CAD model 206 linked to PMI information. When adding a callout the specific view, the radio buttons 306, 308, 310, 312, 314 may be used. For example, radio button 306 may be used to associate the crated callout to an annotation (e.g., PMI annotation). The radio button 308 may be used to include sub callouts, that is, callouts of a callout. The radio button 310 may be used to create a balloon for basic dimensions, e.g., basic PMI dimensions. The radio button 312 may be used to create a balloon for reference dimensions. The radio button 314 may be used to delete all existing balloons in the selected view and replace with new eCAV data. A scroll control 316 may be used to select a desired size percentage for the callout when displayed. A color control 318 may be used to select a color for the displayed callout. When editing an existing callout, the controls 320, 322 may be used to select a callout for editing, while the control 324 may be used to specify a cursor location. The controls 328, 330, and 332 may be used to ok, apply, and cancel the edits via the GUI 300, respectively. The figure also depicts a PMI data 208 and a callout 326 that may have been created and displayed, for example, by the GUI 300, besides a graphical representation 340 of the part design.

Technical effects include systems and methods for conceiving, designing, engineering, manufacturing, verifying, and/or servicing/tracking parts or products, such as turbomachinery parts or products. An electronic Characteristic Accountability & Verification (eCAV) system is provided. The eCAV system may create certain callouts associated with specific PMI annotation objects to identify the objects as inspection items. The eCAV system may then generate a characteristic accountability and verification document that lists each of these inspection items with their nominal values, plus/minus tolerances, units, critical-to-quality (CTQ) types, and other details suitable for use by an inspection operator and/or inspection system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A computer-aided technologies (CAx) system, comprising:
a memory storing a characteristic accountability and verification (eCAV) system; and
a processor communicatively coupled to the memory and configured to execute the eCAV system to:
receive a computer aided design (CAD) model of a part design as input;
add a callout data to the CAD model based on a product and manufacturing information (PMI) data related to the part design; and
link the callout data to the PMI data.

2. The system of claim 1, wherein the eCAV system comprises a graphical user interface (GUI) executable via the processor and configured to:
graphically display a 2-dimensional (2D) representation of the part design, a 3-dimensional (3D) representation of the part design; or a combination thereof on a screen;
receive as input the callout data; and
display a graphical callout representative of the callout data on the screen adjacent to the 2D representation of the part design, the 3D representation of the part design, or a combination thereof.

3. The system of claim 1, wherein the processor is configured to execute the eCAV system to generate a CAV document based on the callout data.

4. The system of claim 3, wherein the CAV document comprises inspection data suitable for inspecting a manufactured part based on the part design.

5. The system of claim 4, wherein the inspection data comprises a nominal value, a plus/minus tolerance, a critical-to-quality (CTQ) type, a statistical process control (SPC) data, a verification (VER) data, a dimension type information comprising a basic, a circular, a chamfer, a degree, a diameter, a surface finish, a radius, a reference, a surface of revolution, a thread, or a combination thereof, a tolerance type information comprising an angularity, a concentricity, a flatness, a non-SPC dimension, a perpendicularity, a parallelism, a runout, a surface, a line profile, a true position, or a combination thereof, a unit of measure, or a combination thereof.

6. The system of claim 3, wherein the memory is storing a Coordinate-Measuring Machine (CMM) inspection program, and wherein the processor is configured to execute the CMM inspection program via a CMM system to inspect, based on the CAV document, a manufactured part manufactured based on the part design, and to produce an inspection record.

7. The system of claim 1, wherein the PMI data comprises a geometric dimension, a tolerances, a text comprising an annotation, a note, or a combination thereof, a non-geometric dimension, a material type, a material specifications, a finish, a clearance, or a combination thereof.

8. The system of claim, wherein the processor is configured to associate the callout data and the PMI data to an entity of the part design and to maintain the association as the entity is further designed via a CAD system.

9. The system of claim 8, wherein the eCAV system is included in the CAD system.

10. A method for applying a computer-aided technologies (CAx) system, comprising:
executing, via a processor, a characteristic accountability and verification (eCAV) system to:
receive, via the processor, a computer aided design (CAD) model of a part design as input;
add, via the processor, a callout data to the CAD model based on a product and manufacturing information (PMI) data related to the part design; and
link, via the processor, the callout data to the PMI data.

11. The method of claim 10, comprising executing, via the processor, a a graphical user interface (GUI) included in the eCAV system to:
graphically display a 2-dimensional (2D) representation of the part design, a 3-dimensional (3D) representation of the part design; or a combination thereof on a screen;
receive as input the callout data; and
display a graphical callout representative of the callout data on the screen adjacent to the 2D representation of the part design, the 3D representation of the part design, or a combination thereof.

12. The method of claim 10, comprising executing, via the processor, the eCAV system to generate a CAV document based on the callout data.

13. The method of claim 12, wherein the CAV document comprises a nominal value, a plus/minus tolerance, a critical-to-quality (CTQ) type, a statistical process control (SPC) data, a verification (VER) data, a dimension type information comprising a basic, a circular, a chamfer, a degree, a diameter, a surface finish, a radius, a reference, a surface of revolution, a thread, or a combination thereof, a tolerance type information comprising an angularity, a concentricity, a flatness, a non-SPC dimension, a perpendicularity, a parallelism, a runout, a surface, a line profile, a true position, or a combination thereof, a unit of measure, or a combination thereof.

14. The method of claim 12, comprising executing, via the processor a Coordinate-Measuring Machine (CMM) inspection program, and wherein the processor is configured to execute the CMM inspection program via a CMM system to inspect, based on the CAV document, a manufactured part manufactured based on the part design, and to produce an inspection record.

15. The method of claim 11 comprising, associating, via the processor, the callout data and the PMI data to an entity of the part design and to maintain the association as the entity is further designed via a CAD system.

16. One or more tangible, non-transitory, machine-readable media comprising instructions configured to cause a processor to:
execute, via the processor, a characteristic accountability and verification (eCAV) system to:
receive, via the processor, a computer aided design (CAD) model of a part design as input;
add, via the processor, a callout data to the CAD model based on a product and manufacturing information (PMI) data related to the part design; and
link, via the processor, the callout data to the PMI data.

17. The one or more machine-readable media of claim 16, comprising instructions configured to cause the processor to execute a graphical user interface (GUI) included in the eCAV system to:
graphically display a 2-dimensional (2D) representation of the part design, a 3-dimensional (3D) representation of the part design; or a combination thereof on a screen;
receive as input the callout data; and
display a graphical callout representative of the callout data on the screen adjacent to the 2D representation of the part design, the 3D representation of the part design, or a combination thereof.

18. The one or more machine-readable media of claim 16, comprising instructions configured to cause the processor to execute the eCAV system to generate a CAV document based on the callout data.

19. The one or more machine-readable media of claim 18, comprising instructions configured to cause the processor to execute a Coordinate-Measuring Machine (CMM) inspection program, and wherein the processor is configured to execute the CMM inspection program via a CMM system to inspect, based on the CAV document, a manufactured part manufactured based on the part design, and to produce an inspection record.

20. The one or more machine-readable media of claim 1, comprising instructions configured to cause the processor to associate the callout data and the PMI data to an entity of the part design and to maintain the association as the entity is further designed via a CAD system.
